(19) United States
(12) Patent Application Publication
(10) Pub. No.: US 2006/0097052 A1
(43) Pub. Date: May 11, 2006

(54) Method and apparatus for acquiring printing medium information using barcode sensors

(76) Inventor: Yu-bin Lee, Seongnam-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/256,058

(22) Filed: Oct. 24, 2005

(30) Foreign Application Priority Data
Nov. 11, 2004 (KR) 10-2004-0091908

(51) Int. Cl. G06K 7/10

(52) U.S. Cl. 235/462.13

(57) ABSTRACT

A printing medium information acquisition method and apparatus for acquiring printing medium information by sensing a plurality of barcodes containing the printing medium information with a plurality of barcode sensors are provided. The printing medium information acquisition apparatus includes a sensing unit having a plurality of sensors for sensing a plurality of barcodes containing printing medium information; and a read-out unit for reading out data of the barcodes based on sense signals of the barcode sensors.

### CROSS-REFERENCE TO RELATED PATENT APPLICATION

This application claims the benefit under 35 U.S.C. §119(a) of Korean Patent Application No. 10-2004-0091908, filed on Nov. 11, 2004, in the Korean Intellectual Property Office, the entire disclosure of which is hereby incorporated by reference.

### BACKGROUND OF THE INVENTION

1. Field of the Invention

The present invention relates to a method and apparatus for acquiring information on a printing medium. More particularly, the present invention relates to a method and apparatus for acquiring printing medium information by sensing a plurality of barcodes containing the printing medium information with a plurality of barcode sensors.

2. Description of the Related Art

Recently, a variety of printing media have been developed. Different printing media may be selected according to types of images and printers or a user's preference. Unfortunately, when printing images on different printing media, the user must individually set up printing control schemes corresponding to the printing media. In addition, the user must set up image printing schemes according to the types of printing media. In order to set up printing media suitable to the image printing scheme, there is a need for information on the printing media.

Therefore, there is a need for a method for efficiently acquiring information on the printing media.

### SUMMARY OF THE INVENTION

Embodiments of the present invention provide a printing medium information acquisition apparatus using a plurality of barcode sensors.

Embodiments of the present invention also provide an image apparatus for controlling an image printing scheme according to printing medium information by using a plurality of barcode sensors.

Embodiments of the present invention also provide a printing medium information acquisition method using a plurality of barcode sensors.

According to an aspect of the present invention, there is provided a printing medium information acquisition apparatus comprising a sensing unit having a plurality of sensors for sensing a plurality of barcodes containing printing medium information. A read-out unit reads out data of the barcodes based on sense signals of the barcode sensors.

According to an aspect of the present invention, the barcode sensors may be disposed symmetrically or asymmetrically with respect to a central line of the information providing medium

According to another aspect of the present invention, there is provided an image printing apparatus comprising a sensing unit having a plurality of sensors for sensing a plurality of barcodes containing information on a printing medium. A read-out unit reads out data of the barcodes based on sense signals of the barcode sensors. A printing medium information extraction unit extracts the printing medium information based on the read-out data of barcodes. A control unit controls a printing scheme of the printing medium based on the extracted printing medium information.

According to still another aspect of the present invention, there is provided a printing medium information acquisition method. The method comprises simultaneously sensing a plurality of barcodes written on an information providing medium and generating a plurality of sense signals. Data of the barcodes is read out based on the sense signals.

### BRIEF DESCRIPTION OF THE DRAWINGS

The above and other features and advantages of the present invention will become more apparent by describing in detail exemplary embodiments thereof with reference to the attached drawings in which:

FIG. 1 is a functional block diagram of a printing medium information acquisition apparatus having a plurality of barcode sensors according to an embodiment of the present invention;

FIG. 2 shows patterns of barcodes written in the information providing medium and positions of barcode sensors according to an embodiment of the present invention;

FIG. 3 is a functional block diagram of an image printing apparatus having a plurality of barcode sensors according to another embodiment of the present invention;

FIG. 4 is a flowchart of a printing medium information acquisition method using a plurality of barcode sensors according to an embodiment of the present invention; and

FIG. 5 is a flowchart of a method of acquiring printing medium information by using a plurality of barcode sensors and printing an image based on the acquired printing medium information according to an embodiment of the present invention.

Throughout the drawings, like reference numbers will be understood to refer to like elements, features and structures.

### DETAILED DESCRIPTION OF EXEMPLARY EMBODIMENTS

A printing medium information acquisition method and apparatus according to exemplary embodiments of the present invention will now be described in detail with referenced to the accompanying drawings.

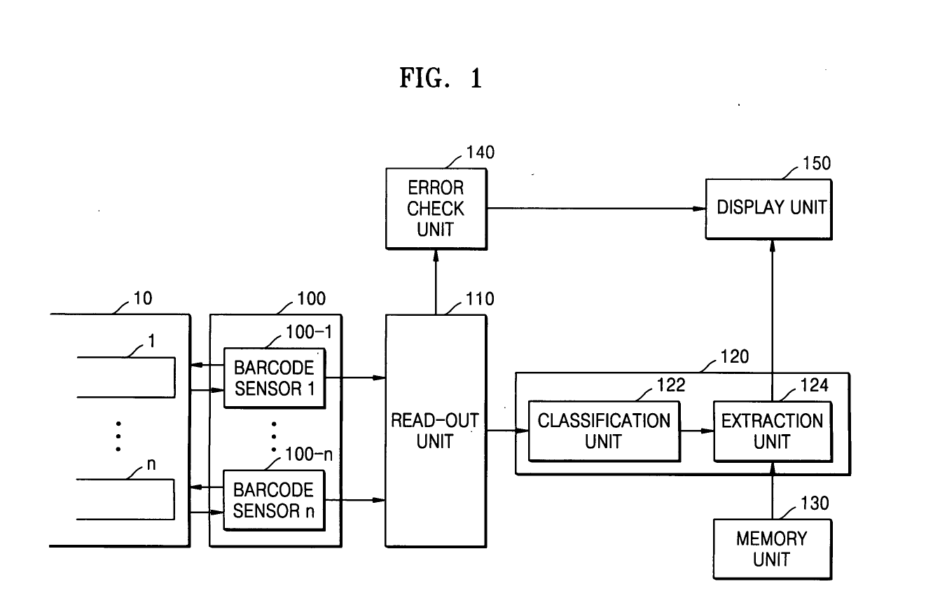

FIG. 1 is a functional block diagram of a printing medium information acquisition apparatus having a plurality of barcode sensors according to an embodiment of the present invention. The printing medium information acquisition apparatus includes a sensor unit 100, a read-out unit 110, a printing medium information extraction unit 120, a memory unit 130, an error check unit 140, and a display unit 150.

The sensor unit 100 senses a plurality of barcodes 1-n written on an information providing medium 10 and generates sense signals corresponding to the sense results. The barcodes 1-n containing the printing medium information are written on the information providing medium 10. The sensor unit 100 includes a plurality of barcode sensors 100-1 through 100-n which simultaneously sense the plurality of barcodes 1-n.

Each of the barcode sensors 100-1 through 100-n of the sensor unit 100 includes a light emitting element (not shown) and a light receiving element (not shown). The light emitting element emits a predetermined light such as a white light on the plurality of barcodes 1-n written on the information providing medium 10. A portion of the light emitted from the light emitting element is reflected on the barcodes. The light receiving element receives the reflected light and generates sense signals corresponding to the intensity of the reflected light.

The read-out unit 110 reads out data of the barcodes based on the sense signals input from the sensor unit 100. The sense signals input from the sensor unit 100 are preferably analog electrical signals corresponding to the intensity of reflected light. The barcodes preferably include black and white bars. The intensity of the reflected light of the black bar is normally smaller than that of the white bar. The read-out unit 110 reads out the data of the barcodes by allocating a value of 0 to regions of the sense signal having an intensity less than a first threshold value and a value of 1 to regions of the sense signal having an intensity more than the first threshold value.

The medium information extraction unit 120 extracts the printing medium information from the memory unit 130 corresponding to the data of the barcodes transmitted from the read-out unit 110. An exemplary medium information extraction unit 120 includes a classification unit 122 and an extraction unit 124.

The classification unit 122 classifies the read-out data of the barcodes into predetermined printing medium information parameters. For example, the first and last few data pieces of the barcodes are used as printing medium information parameters for indicating start and end portions of the data of the barcodes. Some data pieces of the barcodes are used as parameters for indicating printing set-up information of the image printing apparatus. In addition, other data pieces of the barcodes are used as parameters for indicating a size, type, and version of the printing medium and printing control information according to the type and version of the printing medium.

The extraction unit 124 extracts the printing medium information from the memory unit 130 corresponding to the data of the barcodes classified into printing medium information parameters. The memory unit 130 stores the printing medium information corresponding to the data of the barcodes classified into printing medium information parameters. The printing medium information includes information on a size, type, and version of the printing medium and printing control information according to the type and version of the printing medium.

Preferably, the printing medium information acquisition apparatus may further include an error check unit 140 for checking an extraction error of the printing medium information based on the number of bars having predetermined widths. For example, the barcodes preferably include 3 bars having a width of 1 unit (such as a mm), 2 bars having a width of 2 units, 2 bars having a width of 3 units, and one bar having a width of 4 units. When the error check unit 140 senses 3 bars having a width of 1 unit, 2 bars having a width of 2 units, 2 bars having a width of 3 units, and one bar having a width of 4 units, it is determined that the read-out of printing medium information was performed without error.

The display unit 150 displays the extracted printing medium information, so that a user can see the printing medium information.

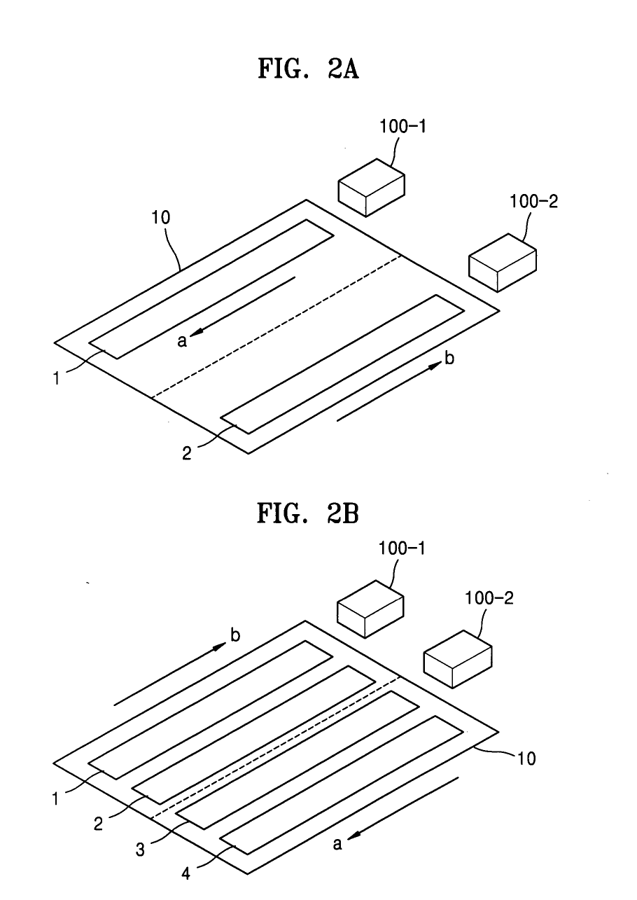

FIGS. 2A and 2B shows patterns of barcodes barcode sensors in the printing medium information acquisition apparatus according to an embodiment of the present invention. Referring to FIG. 2A, two barcode sensors 100-1 and 100-2 sense two barcodes written on the information providing medium 10. The two barcode sensors 100-1 and 100-2 are disposed symmetrically with respect to a central line of the information providing medium 10. In addition, the barcodes 1 and 2 are also written symmetrically with respect to the central line of the information providing medium 10. By moving the information providing medium 10 in the direction of the arrow b, the two barcodes 1 and 2 are sensed in the direction of the arrow a by the two barcode sensors 100-1 and 100-2 to generate the sense signals.

Referring to FIG. 2B, two barcode sensors 100-1 and 100-2 sense four barcodes 1 to 4 written on the information providing medium 10. The two barcode sensors 100-1 and 100-2 are disposed asymmetrically with respect to a central line of the information providing medium 10. However, the four barcodes 1 to 4 are written symmetrically with respect to the central line of the information providing medium 10. By moving the information providing medium 10 in the direction of the arrow b, the two barcodes 1 and 3 are sensed in the direction of the arrow a by the two barcode sensors 100-1 and 100-2 to generate the sense signals. In addition, after the information providing medium 10 rotates by 180°, by moving the information providing medium 10 in the direction of the arrow b, the two barcodes 2 and 4 are sensed in the direction of the arrow a by the two barcode sensors 100-1 and 100-2 to generate the sense signals.

As will be appreciated by those of ordinary skill in the art, the format and position of barcodes described herein are merely exemplary. The position and pattern of the barcode written on the information providing medium may of course be modified. In addition, the positions of the barcode sensors may be modified according to the patterns and positions of the barcodes. Such modifications should be understood as being included in the scope of the present invention.

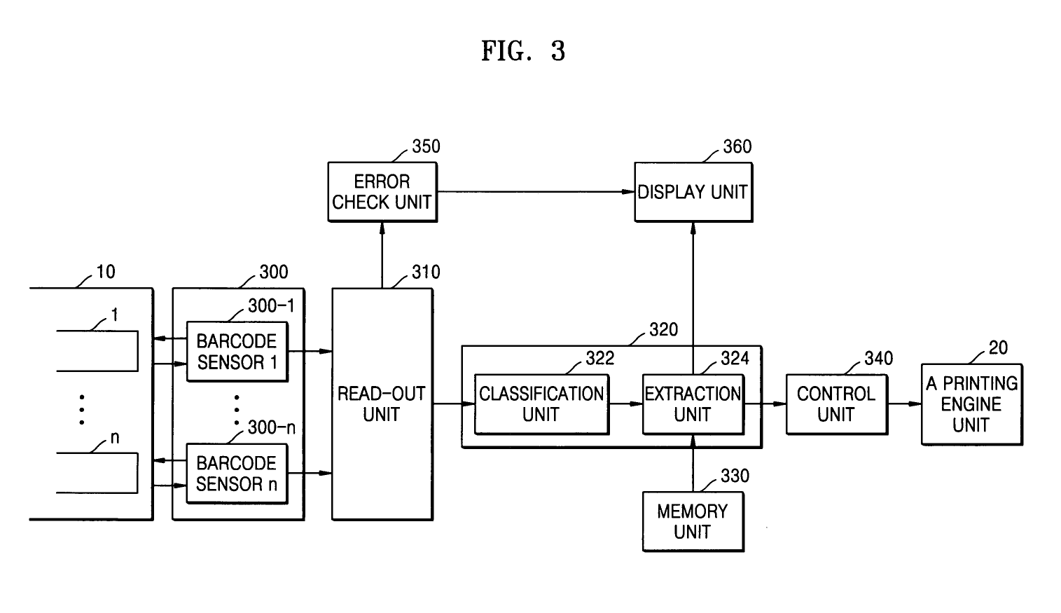

FIG. 3 is a functional block diagram of an image printing apparatus having a plurality of barcode sensors according to another embodiment of the present invention. The image printing apparatus includes a sensor unit 300, a read-out unit 310, a printing medium information extraction unit 320, a memory unit 330, a control unit 340, an error check unit 350, and a display unit 360. The sensor unit 300, the read-out unit 310, the printing medium information extraction unit 320, the memory unit 330, the error check unit 350, and the display unit 360 shown in FIG. 3 have substantially the same operations as the sensor unit 100, the read-out unit 110, the printing medium information extraction unit 120, a memory unit 130, the error check unit 140, and the display unit 150 shown in FIG. 1, respectively. Therefore, description thereof will be omitted.

The control unit 340 controls a printing engine 20 based on the printing medium information extracted from the printing medium information extraction unit 320. The printing engine 20 prints a predetermined image on the printing medium with the most suitable printing scheme under the control of the control unit 340.

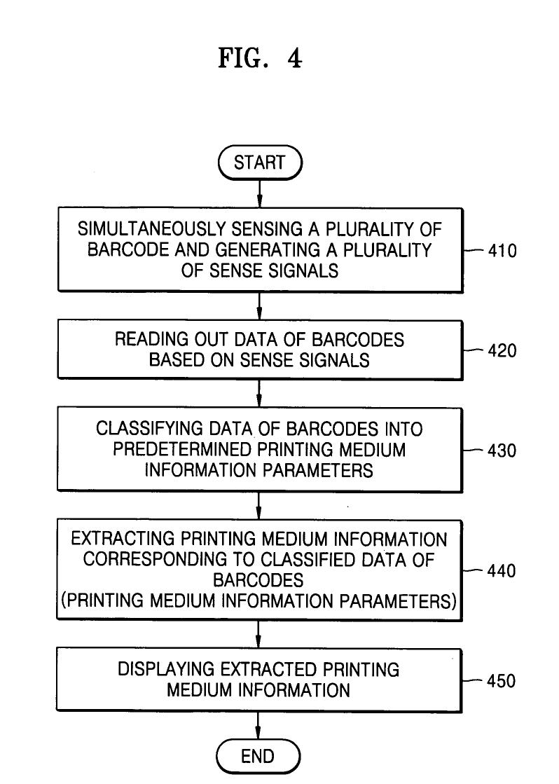

FIG. 4 is a flowchart of a printing medium information acquisition method using a plurality of barcode sensors according to an embodiment of the present invention. Firstly, when a plurality of barcodes written on an information providing medium is input to a printing medium information acquisition apparatus, the plurality of barcodes are simultaneously sensed by a plurality of barcode sensors, and sense signals corresponding to the sense results are generated (operation 410). More specifically, each of the barcode sensors includes light emitting and receiving elements. The light emitting element emits light to the barcode, and the light receiving element receives the light reflected from the barcode. The intensity of the sense signal is proportional to the intensity of the reflected light.

Data of the barcodes is read out based on the generated sense signal (operation 420). In a predetermined interval of the sense signal, digits 0 and 1 are allocated to the regions of the barcode generating a sense signal having an intensity less than a first threshold value and other regions of the barcode generating a sense signal having an intensity more than the first threshold value.

Printing medium information is extracted based on the read-out data of the barcodes (operation 430 and 440). The read-out data of barcodes are classified into predetermined printing medium information parameters (operation 430). The printing medium information corresponding to the predetermined printing medium information parameters is extracted from a memory unit (operation 440). The extracted printing medium information is displayed on a display unit (operation 450).

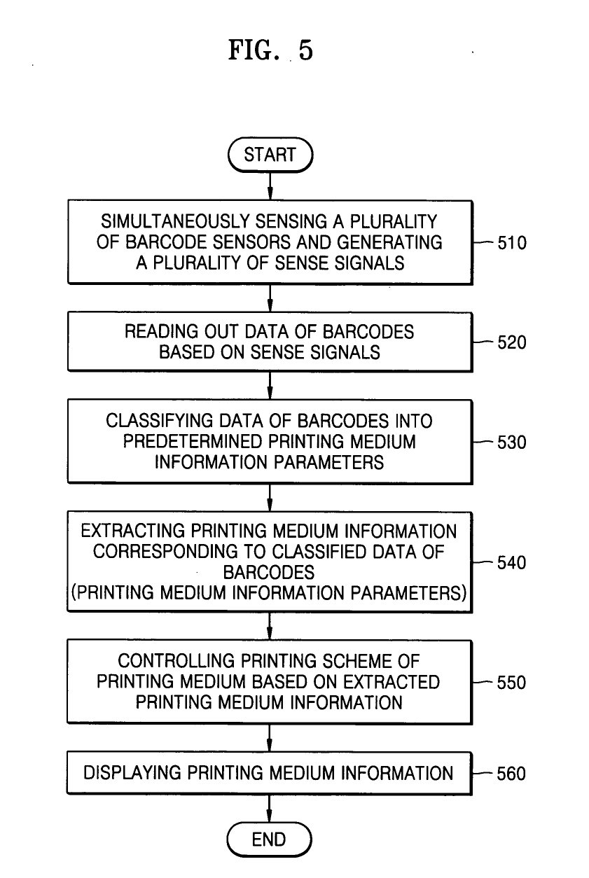

FIG. 5 is a flowchart of a method of acquiring printing medium information by using a plurality of barcode sensors and printing an image based on the acquired printing medium information according to an embodiment of the present invention. The plurality of barcodes written on an information providing medium are sensed by a plurality of barcode sensors to generate sense signals. Data of the barcodes are read out based on the generated sense signal. Printing medium information is extracted based on the read-out data of the barcodes (operations 510 to 540). The operations 510 to 540 of FIG. 5 are substantially the same as the operations 410 to 440 of FIG. 4. Therefore, the detailed description on the operations 510 to 540 will be omitted.

The printing scheme is controlled to print a predetermined image on the printing medium based on the extracted printing medium information (operation 550). The extracted printing medium information preferably includes information on a size, type, and version of the printing medium and printing control information according to the type and version of the printing medium. The printing scheme of the image printing apparatus is controlled based on the extracted printing medium information. Preferably, the extracted printing medium information is displayed on the display unit, so that a user can see the extracted printing medium information (operation 560).

According to embodiments of the present invention, since a plurality of barcodes containing printing medium information are sensed by a plurality of barcode sensors, it is possible to rapidly acquire a large amount of printing medium information.

In addition, according to embodiments of the present invention, the barcode sensors are disposed symmetrically or asymmetrically with respect to a central line of the information providing medium, and the barcodes are written on one surface or both surfaces of the information providing medium symmetrically or asymmetrically with respect to the central line, so that the plurality of barcodes can be sensed by using fewer barcode sensors than barcodes printed on the printing medium.

Embodiments of the present invention can be written as computer programs and can be implemented in general-use digital computers that execute the programs using a computer readable recording medium. Examples of the computer readable recording medium include magnetic storage media (such as, ROM, floppy disks, hard disks, and so on), optical recording media (such as, CD-ROMs, DVDs, and the like), and storage media such as carrier waves (such as, transmission through the Internet).

While the present invention has been particularly shown and described with reference to exemplary embodiments thereof, it will be understood by those skilled in the art that various changes in form and details may be made therein without departing from the spirit and scope of the present invention as defined by the appended claims.

What is claimed is:

1. A printing medium information acquisition apparatus comprising:
a sensing unit having a plurality of sensors for sensing a plurality of barcodes containing printing medium information; and
a read-out unit for reading out data of the barcodes based on the sense signals of the barcode sensors.

2. The printing medium information acquisition apparatus according to claim 1, further comprising an information providing medium on which the barcodes are written.

3. The printing medium information acquisition apparatus according to claim 2, wherein the barcode sensors are disposed symmetrically with respect to a central line of the information providing medium.

4. The printing medium information acquisition apparatus according to claim 3, wherein the barcodes are written on one surface of the information providing medium symmetrically with respect to a central line of the information providing medium.

5. The printing medium information acquisition apparatus according to claim 3, wherein the barcodes are written on both surfaces of the information providing medium symmetrically with respect to a central line of the information providing medium.

6. The printing medium information acquisition apparatus according to claim 2, wherein the barcode sensors are disposed asymmetrically with respect to a central line of the information providing medium.

7. The printing medium information acquisition apparatus according to claim 6, wherein the barcodes are written on one surface of the information providing medium asymmetrically with respect to a central line of the information providing medium.

8. The printing medium information acquisition apparatus according to claim 6, wherein the barcodes are written on both surfaces of the information providing medium asymmetrically with respect to a central line of the information providing medium.

9. The printing medium information acquisition apparatus according to claim 1, further comprising a printing medium information extraction unit for extracting the printing medium information based on the read-out data of barcodes.

10. The printing medium information acquisition apparatus according to claim 9, wherein printing medium information extraction unit comprises:
a classification unit for classifying the read-out data of barcodes into predetermined printing medium information parameters; and
an extraction unit for extracting the printing medium information corresponding to the data of barcodes classified into the printing medium information parameters.

11. The printing medium information acquisition apparatus according to claim 9, further comprising a memory unit for storing the printing medium information corresponding to the data of barcodes classified into the printing medium information parameters.

12. The printing medium information acquisition apparatus according to claim 9, further comprising a display unit for displaying the printing medium information.

13. The printing medium information acquisition apparatus according to claim 1, wherein the printing medium information includes information on at least a size, type, and version of the printing medium and printing control information according to the type and version of the printing medium.

14. An image printing apparatus comprising:
a sensing unit having a plurality of sensors for sensing a plurality of barcodes containing information on a printing medium; and
a read-out unit for reading out data of the barcodes based on sense signals of the barcode sensors;
a printing medium information extraction unit for extracting the printing medium information based on the read-out data of barcodes; and
a control unit for controlling a printing scheme of the printing medium based on the extracted printing medium information.

15. A printing medium information acquisition method comprising:
simultaneously sensing a plurality of barcodes written on an information providing medium and generating a plurality of sense signals; and
reading out data of the barcodes based on the sense signals.

16. The printing medium information acquisition method according to claim 15, wherein the barcodes are written on one surface of the information providing medium symmetrically with respect to a central line of the information providing medium.

17. The printing medium information acquisition method according to claim 15, wherein the barcodes are written on both surfaces of the information providing medium symmetrically with respect to a central line of the information providing medium.

18. The printing medium information acquisition method according to claim 15, wherein the barcodes are written on one surface of the information providing medium asymmetrically with respect to a central line of the information providing medium.

19. The printing medium information acquisition method according to claim 15, wherein the barcodes are written on both surfaces of the information providing medium asymmetrically with respect to a central line of the information providing medium.

20. The printing medium information acquisition method according to claim 15, further comprising extracting the printing medium information based on the read-out data of barcodes.

21. The printing medium information acquisition method according to claim 20, wherein the extracting step further comprises:
classifying the read-out data of barcodes into predetermined printing medium information parameters; and
extracting the printing medium information corresponding to the data of barcodes classified into the printing medium information parameters.

22. The printing medium information acquisition method according to claim 20, further comprising controlling a printing scheme of the printing medium based on the extracted printing medium information.

23. The printing medium information acquisition method according to claim 15, further comprising displaying the printing medium information.

24. The printing medium information acquisition method according to claim 15, wherein the printing medium information includes at least a type and version of the printing medium and printing control information corresponding to the type and version of the printing medium information.

25. A computer-readable medium having embodied thereon a computer program for performing the method of claim 15.
